(19) United States
(12) Patent Application Publication
(10) Pub. No.: US 2008/0180739 A1
(43) Pub. Date: Jul. 31, 2008

(54) METHOD AND SYSTEM FOR SENDING MESSAGES

(75) Inventor: Jelle WIERSMA, Drachtser Compagnie (NL)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (FR)

(21) Appl. No.: 12/020,936

(22) Filed: Jan. 28, 2008

(30) Foreign Application Priority Data
Jan. 31, 2007 (EP) 07101528.3

(51) Int. Cl. G06F 3/12

(52) U.S. Cl. 358/1.15

(57) ABSTRACT

Printed documents containing messages are processed into mail pieces using a system for preparing mail pieces. Data representing images of at least some of the documents are obtained by an imaging device of system for preparing mail pieces. The mail pieces are delivered to a postal service for delivery of the mail pieces to addressees and data sets representing at least some of the images in digital form are transmitted electronically. A system for carrying out such a method is also described.

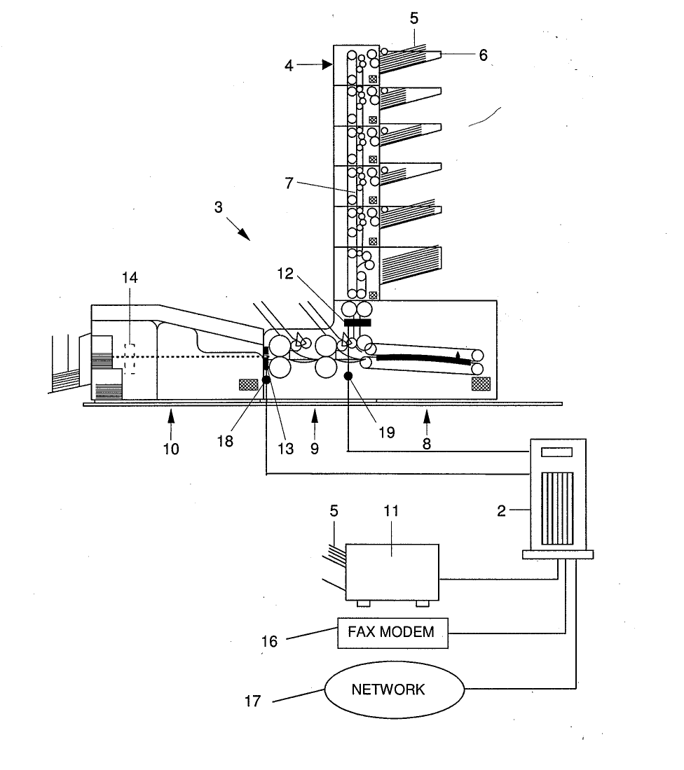

### FIELD AND BACKGROUND OF THE INVENTION

The invention relates to a method and a system for sending messages. For sending messages, various communication channels are available. For instance, documents of some length may be sent as physical documents by mail or in electronic form via a fax machine, as an e-mail message, attached to an e-mail message or in html form referred to by a hyperlink.

In many cases, it is advantageous to have several communication channels available, for instance to send documents both quickly in electronic form and, more slowly, as originals in paper form, which may for instance be signed. The ability of automatically sending out messages both in electronic form and in physical (generally paper) form is particularly advantageous if messages are to be sent to a large number of addressees with different characteristics with respect to the form in which the documents are preferably received.

In European patent application 0 917 075 and in U.S. Pat. No. 6,483,599, it is described to generate messages by processing a print stream. However, this requires a print stream processor and measures to identify the beginnings and ends of documents in a print stream. Moreover, the print stream processor must be compatible with the print stream language and should not be disturbed by particular characteristics of the instructions required by a printer for which a print stream is intended.

In U.S. Pat. No. 6,157,924, a messaging system that purports to provide a uniform presentation of information regardless of the medium used for sending a message to a recipient. However, such a messaging system is difficult to integrate with an existing communication structure.

### SUMMARY OF THE INVENTION

It is an object of the present invention to provide an easily implementable solution that allows to send messages by mail and electronically.

According to the invention, this object is achieved by providing a method for sending messages, including: providing a system for preparing mail pieces including an imaging device; providing printed documents containing the messages, each document comprising at least one printed sheet; feeding and transporting the documents through the system for preparing mail pieces to the imaging device; obtaining data representing images of at least some of the documents by the imaging device; preparing mail pieces from at least some of the documents by the system for preparing mail pieces; delivering the mail pieces to a postal service for delivery of the mail pieces to addressees; and electronically transmitting data sets representing at least some of the images in digital form. The invention may also be embodied in a system for sending messages, including:

at least one station for processing documents into mail pieces mail pieces, the documents containing the messages and each being constituted by at least one printed sheet; an imaging device for obtaining data representing images from the documents; a transport track for transporting documents to the imaging device and from the imaging device to the at least one station for processing documents; and an output port communicating with the imaging device for outputting data sets of the stored data representing at least some of the obtained images, which is specifically adapted for carrying out a method according to the invention.

Because the electronic messages are generated on the basis of images scanned from documents that are processed in the system for preparing mail pieces, the generation of electronic messages can be left independent of the information and communication structure used for generating the messages and requires very little if any adaptation of the information and communication infrastructure.

Particular elaborations and embodiments of the invention are set forth in the dependent claims. Further features, effects and details of the invention appear from the detailed description and the drawing.

### BRIEF DESCRIPTION OF THE DRAWINGS

The drawing is a schematic representation of an example of a system according to the invention.

### DETAILED DESCRIPTION

In the drawing, a system is shown, which is composed of a computer 2, a printer 11, a mail preparation apparatus 3 for processing printed documents into mail pieces, a fax modem 16 and a network connection 17.

The mail preparation apparatus 3 is equipped with a plurality of sheet feeders 4 for individually feeding sheets 5 from hoppers 6 (reference numbers designate only a topmost one of the feeding stations). The sheet feeders 4 each have conveyor belts and the conveyor belts of the successive stations 4 define a sheet transport path 7 through the feeding stations.

The transport track 7 leads to an aligning station 8 for aligning transported sheets that are to be stacked into a set of sheets having on one side substantially aligned sheet edges. A discharge track of the aligning station 8 leads to a folding station 9 for folding sheets supplied from the aligning station 8. An inserting station 10 is arranged downstream of and next to the folding station 9. A similar system is known from and described in more detail in U.S. Pat. No. 5,556,086.

Downstream of the feeder stations 4, a first imaging device in the form of a first scanner 12 for obtaining images from the transported sheets is arranged along the transport track 7. A second imaging device, also in the form of a scanner 13 for obtaining images from the transported sheets, is arranged along the transport path 7 immediately upstream of the inserter station 10. A third imaging device, also in the form of a scanner 14, is arranged in the inserting station 10 for obtaining images from the mail pieces after insertion of the respective folded sheets into the envelope. The third scanner 14 may scan the portions of the sheets that are visible through the envelope windows, typically showing the address information or the scanner may scan the outside of the envelope bearing address data printed thereon.

Output ports 18, 19, communicate with the scanners 12, 13 for outputting data sets of the stored data representing at least some of the obtained images. The output ports are connected to the computer 2 so that the outputted data are transferred to the computer 2. The computer is arranged for storing the received data outputted from the scanners 12, 13. The computer 2 is connected to a fax modem 16 and to a network connection 17, which may for instance be a network server or a hub/router. The network connection 17 preferably provides access to the Internet.

For preparing items to be mailed, sheets are printed by the printer 11 on basis of a print stream the printer receives from the computer 2. A stack of the printed sheets 5 is subsequently transported from the printer 11 to a feeding station 4 of the mail preparation apparatus 3 and loaded into a hopper 6 of a the feeding station 4. Sheets and inserts that are to be accumulated into sets are gathered and aligned along a leading edge in the accumulating station 8. The gathered and aligned sheets are then transported to the folding station 9 with the edges that are mutually aligned trailing and folded in the folding station 9. Finally, each set of folded sheets is inserted into an envelope in the inserting station 10 and the envelopes with the sheets inserted therein (and generally also with the envelope flap closed) are outputted from the inserting station 10.

As the sheets are fed and transported through the system 3, the sheets are also transported to the scanner 12, where an image may be scanned from each sheet individually or from selected sheets only and after folding, the sheets, which may have been gathered into sets are also transported along the second and third scanners 14 where scanned images or other scanned data may be used for monitoring the progress of the sheets through the system.

Data representing images obtained by the scanner 12 are transferred to the computer 2 and stored while mail pieces are prepared from at least some of the documents by the system 3.

After the mail pieces have been completed, the mail pieces are delivered to a postal service for delivery of the mail pieces to addressees. Data sets of the stored data representing at least some of the images are transmitted electronically in digital form via the fax modem 16 and/or the network connection 17. This allows the recipient to display the obtained images. The electronic messages may for instance be sent to the addressees to notify that the documents has been sent or to another address such as the address of a third party or department to provide an electronic copy of a paper document that has been sent. The third party may for instance be a third party on whose behalf the paper documents are prepared and sent.

Thus, the messages can be sent to addressees in electronic form as well, without requiring adaptations to the message generation process. Moreover, because the electronically sent messages are based on images obtained from the paper documents, consistency between the message in the paper document and the electronically sent message is ensured easily and very reliably.

A particularly easy implementation of the additional electronic transmission of messages is achieved if the addresses to which the data sets are sent are determined in accordance with indicia included in the obtained images. Such indicia may for instance be customer identification numbers or e-mail addresses printed on the document.

The indicia may for instance be alphanumeric letters and/or numbers obtained from the document and the electronic addresses may be determined by matching the indicia with data in or associated to the respective electronic addresses. This allows to automatically send the electronic messages to electronic addresses without having to print the electronic addresses or direct references thereto on the documents.

The printing of addresses on envelopes into which the documents are to be inserted can be achieved in a particularly simple and efficient manner if the addresses to be printed on the envelopes are determined in accordance with the data representing images that are obtained from the documents.

If the data sets are outputted in response to completion of the associated mail piece, for instance as determined on the basis of a scanning result obtained by the scanner 14, the sending of an electronic message can be used as evidence that the associated mail piece has been completed. This is of particular advantage, if the mail pieces are prepared for a third party or a department, which needs to be notified of the progress of the preparation of the mail pieces.

If the data sets are sent electronically in response to a confirmation of receipt of the associated mail piece at a delivery service network, such as a postal service, such a third party or department can use the receipt of the electronic copy a evidence that a mail piece has been mailed or offered for dispatch otherwise.

Because the scanner 12 is arranged downstream of the feeder stations 4, the scanner 12 is suitable for scanning images form any of the feeder stations 4. This allows to obtain images from main documents and from enclosures to be accumulated with the main document at the accumulating station. Thus the outputted data sets may also represent at least some of the images obtained from inserts to be added to the main documents.

While the invention has been illustrated and described in detail in the drawings and foregoing description, such illustration and description are to be considered illustrative or exemplary and not restrictive; the invention is not limited to the disclosed embodiments.

For example, it is possible to provide the imaging device in another form than in the form as a scanner, for instance in the form of a digital camera. Also, separate imaging devices may be provided for obtaining images from sheets in or fed from each feeding station. Furthermore, the printer may be arranged in-line with the mail preparation system for transferring printed sheets to the mail preparation, or to a buffer station, one by one as the sheets have are printed. Other variations to the disclosed embodiments can be understood and effected by those skilled in the art in practicing the claimed invention, from a study of the drawings, the disclosure, and the appended claims.

1. A method for sending messages, comprising:
providing a system for preparing mail pieces including an imaging device;
providing printed documents containing the messages, each document comprising at least one printed sheet;
feeding and transporting the documents through the system for preparing mail pieces to the imaging device;
obtaining data representing images of at least some of the documents by the imaging device;
preparing mail pieces from at least some of the documents by the system for preparing mail pieces;
delivering the mail pieces to a postal service for delivery of the mail pieces to addressees; and
electronically transmitting data sets representing at least some of the images in digital form.

2. A method according to claim 1, wherein addresses to which the data sets are sent are determined in accordance with indicia included in the obtained images.

3. A method according to claim 2, wherein the indicia are alphanumeric letters and/or numbers scanned from the document and wherein electronic addresses are determined by matching the indicia with data in or associated to the respective electronic addresses.

4. A method according to claim 1, wherein the mail pieces include envelopes into which the documents are inserted, further comprising printing addresses on the envelopes in accordance with the data representing images of the documents.

5. A method according to claim 1, wherein the data sets are outputted in response to completion of the associated mail piece.

6. A method according to claim 1, wherein the data sets are sent in response to conformation of receipt of the associated mail piece in a delivery service network.

7. A system for sending messages, comprising:
at least one station for processing documents into mail pieces mail pieces, the documents containing the messages and each being constituted by at least one printed sheet;
an imaging device for obtaining data representing images from the documents;
a transport track for transporting documents to the imaging device and from the imaging device to the at least one station for processing documents; and
an output port communicating with the imaging device for outputting data sets of the stored data representing at least some of the obtained images.

8. A system according to claim 7, further comprising:
at least one insert feeding station for adding inserts to documents being processed; and
at least one imaging device for obtaining images from inserts in or fed from the insert feeding station, said imaging device communicating with the output port for outputting data sets representing at least some of the images obtained from the inserts.
